(19) United States
(12) Patent Application Publication
(10) Pub. No.: US 2024/0111882 A1
(43) Pub. Date: Apr. 4, 2024

(54) Automatic Classification of Files with Hierarchical Structure with the Digital Fingerprints Library

(71) Applicant: Acronis International GmbH, Schaffhausen (CH)

(72) Inventors: Nickolay Berko, Schaffhausen (CH); Serg Bell, Singapore (SG); Stanislav Protasov, Singapore (SG)

(21) Appl. No.: 17/936,410

(22) Filed: Sep. 29, 2022

(51) Int. Cl. G06F 21/62; G06F 16/13; G06F 16/185

(52) U.S. Cl. CPC G06F 21/6218; G06F 16/137; G06F 16/185

(57) ABSTRACT

A system and a method for automatically assigning a hierarchical security level to a source of data, e.g., a file or a database, that can be used as a source to generate, e.g., to calculate or to extract, fingerprints of fragments of a fixed size N using a digital fingerprint library that contains fingerprints of known fragments fixed size and their hierarchical security levels are disclosed herein. The method comprises assignment of an initial hierarchical security level to a source of data and further comparison of fingerprints of its fragments of fixed size to the fingerprints of fingerprints of fixed size and their related hierarchical security levels stored in the digital fingerprint library.

### FIELD OF THE INVENTION

The present disclosure generally relates to data security. In particular, the present disclosure relates to a system and method for automatically assigning a hierarchical security level to a source M, e.g., a file or a database, of fingerprints, e.g., hashes by comparing fingerprints F(i) generated from the source M, to fingerprints F(X) stored in a digital fingerprint library along with the hierarchical security levels L(X) of these fingerprints F(X), where all fingerprints F are fingerprints of fragments K of the same length N.

### BACKGROUND OF THE INVENTION

With the advent of digital technology and the ever-increasing value of digital assets and related cyber security threats, data security has become a critical issue in all aspects of computer technology. Organizations and private citizens store valuable information in their information systems. While a company may have internal controls to safeguard its digital assets within the corporate security perimeter, once such information leaves that perimeter, it may be harder to control it.

To better manage digital assets and prevent unauthorized release of these assets, companies deploy automatic systems that detect events when certain information is about to cross corporate virtual security perimeter. One of the methods to do so is fingerprinting of known documents that contain protected data. That method creates fingerprints of known documents that contain protected data, and when an unknown file is about to cross the virtual security perimeter, the fingerprint of that file is compared to the fingerprints of all known files that contain protected information. If the fingerprint of the unknown file matches one of the fingerprints of the files known to contain protected information, it is also marked as containing protected information.

A similar problem arises when there is a need to identify files containing partial fragments that have been copied from files known to contain protected information. In that case, fingerprinting of the entire file will not be able to detect the presence of a fragment of one file within another file when even at least one symbol in these files is different.

### SUMMARY OF THE INVENTION

The present invention concerns a Digital Fingerprint Library (“DFL”). It operates in an environment where files and fragments have an explicit or implicit hierarchical security level Level(i), such that when i>j, the hierarchical security level Level(i) corresponding to the number i is a higher hierarchical security level than the security level Level(j) corresponding to the number j. These levels may be named or numbered as Level(0), Level(1), . . . , Level(m).

A fingerprint is a value generated based on the contents of a fragment of fixed length N such that when two fingerprints are different, with large probability the sources of these fingerprints are also different. An example of a fingerprint is a hash function including a cryptographic hash function. Usually, digital fingerprints have the same size. For a fragment of fixed length N, the fragment itself may be its own fingerprint.

The present disclosure describes the method for automatically assigning a hierarchical security level to a source M of fingerprints F(i) of N-fragments K(i) by comparing fingerprints F(i) of N-fragments K(i) generated from that source M to fingerprints F(X) of N-fragments K(X) stored in a digital fingerprint library DFL with their hierarchical security levels L(X).

Generation of the digital fingerprint library DFL based on fingerprints F(X) of known N-fragments K(X) and their hierarchical security levels is a subject of different disclosure. Briefly, DFL contains fingerprints F(X) of N-fragments K(X) along with their hierarchical security levels L(X). If several identical fingerprints with different hierarchical security levels were encountered during the DFL construction process, DFL contains the lower hierarchical security level assigned to different instances of that fingerprint.

Current disclosure uses that DFL as a source of information for fingerprint comparison.

Specifically, the method of this invention is comprised of accepting the source M of fingerprints F(i) of N-fragments K(i) for examination, e.g., a file or a database, determining current hierarchical security level L(M) of that source M, extracting fingerprints F(i) of N-fragments K(i) from that source using the sliding window method, and comparing fingerprints F(i) of these N-fragments K(i) to the fingerprints F(X) stored within DFL.

In an embodiment, the step of extracting fingerprints F(i) of N-fragments K(i) is preceded by the step of calculating fingerprints F(i) of N-fragments K(i).

In an embodiment, the source M only contains fingerprints F(i) of N-fragments K(i) and their hierarchical security levels, e.g., a database for remote processing and automatic assignment of hierarchical security level without exposing the protected data to the examination system.

In an embodiment, if the source M does not have a hierarchical security level assigned to it yet, the initial value of the hierarchical security level L(M) of that source M is set to the lowest hierarchical security level Level(0).

In an embodiment, if the source M does not have a hierarchical security level assigned to it yet, the initial value of the hierarchical security level L(M) of that source M is set according to a predefined rule.

Each time a fingerprint F(X) is found within DFL that matches a fingerprint F(i) generated from the source M such that the hierarchical security level L(X) of that fingerprint F(X) exceeds the current hierarchical security level L(M) of the source M, the hierarchical security level L(M) of the source M is set to equal L(X).

The present invention also discloses a system for assigning a hierarchical security level to source M of fingerprints F(i) of N-fragments K(i) based on the information from a DFL that contains fingerprints F(X) of N-fragments K(X) and their respective hierarchical security levels L(X).

The system comprises a Source Processor and a Comparator to DFL.

Source Processor is configured to receive a source M of fingerprints F(i) of N-fragments K(i), to determine the original hierarchical security level L(M) of that collection, to generate fingerprints F(i), and to fragments F(i) and the current hierarchical security level L(M) to the Comparator to DFL for processing.

The Comparator to DFL is configured to receive fingerprints F(i) of N-fragments K(i) generated from the source M with its initial hierarchical security level L(M), to compare fingerprints F(i) generated from the source M to fingerprints F(X) stored in the DFL and, if a match is found, compare the current hierarchical security level L(M) of the source M to the hierarchical security level L(X) of the matching fingerprint F(X). If the hierarchical security level L(X) of a matching fingerprint F(X) is greater than the current hierarchical security level L(M) of the source M, then the Comparator is configured to change the hierarchical security level L(M) of the source M to equal to L(X).

In an embodiment, the source M is a file, and fingerprints F(i) are generated from N-fragments K(i) generated from the file with the use of the sliding window process.

In an embodiment, the source M is a database that contains fingerprints, N-fragments, or sources of them, e.g., textual messages of length greater than N.

In an embodiment, the source M is initially assigned the lowest hierarchical security level.

In one embodiment, the Comparator to DFL uses a hash value of N-fragments as their fingerprint.

In an embodiment, the Comparator to DFL uses the value of the N-fragment as its own fingerprint.

### DESCRIPTION OF THE DRAWINGS

FIG. 1 shows a block diagram depicting the method of automatically assigning a hierarchical security level L(M) to a source M by comparing fingerprints F(i) generated from that source to the fingerprints F(X) in the DFL where fingerprints F(i) and F(X) are fingerprints of some N-fragments K(i) according to the current disclosure.

FIG. 2 shows a block diagram depicting the method for automatically assigning a hierarchical security level L(M) to a file M by generating N-fragments K(i) from that file, further generating fingerprints F(i) of these N-fragments N(i) and comparing these fingerprints F(i) to the fingerprints F(X) in the DFL according to an embodiment.

FIG. 3 shows a block diagram of the system according to current disclosure.

### DETAILED DESCRIPTION

A digital fingerprint library (“DFL”) comprises a collection of fingerprints F(X) of N-fragments K(X) and their hierarchical security levels L(X). A DFL may also be referred to as a fingerprint library or database.

Protected information includes information including trade secrets, patented data, confidential and proprietary business information, and any other information of the Company, including, but not limited to, customer lists (including potential customers), sources of supply, processes, plans, materials, pricing information, internal memoranda, marketing plans, internal policies, and products and services which may be developed from time to time by the Company and its agents or employees. Protected information may alternatively be used as protected data or files.

An unknown file or document comprises a file or a document that has not been subject to analysis for assignment of hierarchical security level. In one example, the unknown file or unknown document is a document that a user prepared just before the instant of file transmission via email or copying to an external USB device.

The present disclosure describes a system and method for assigning a hierarchical security level to an unknown file, database, or other source of digital fingerprints, using a digital fingerprint library that stores fingerprints of N-fragments and their hierarchical security levels.

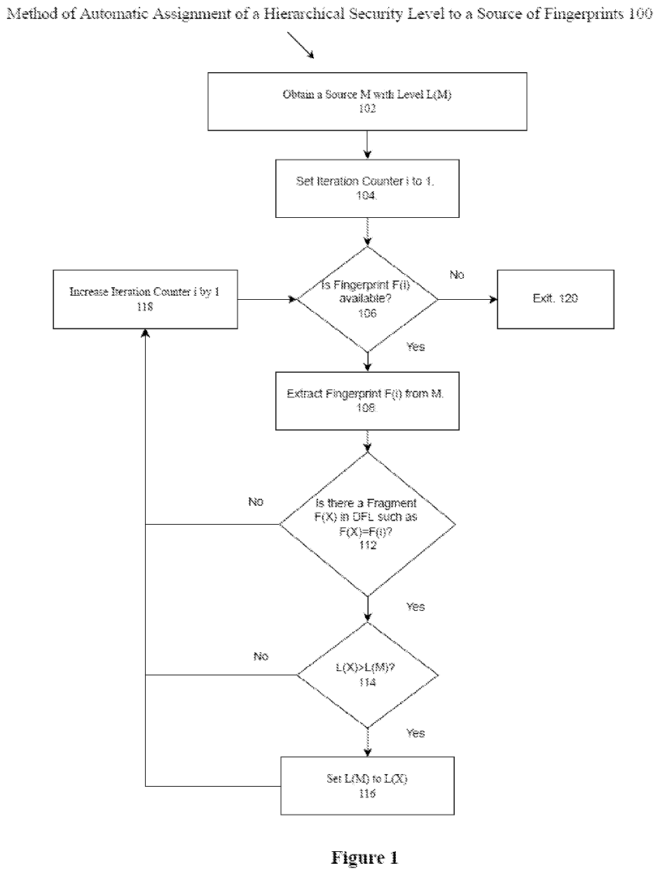

FIG. 1 is a block diagram depicting the method 100 of assigning a hierarchical security level L(M) to source M, in accordance with current disclosure.

The method 100 obtains a source M with hierarchical security level L(M) at step 102.

At step 104, an iterative process starts. The iteration counter i is only an indicator to enumerate different steps of the process. The process may use iterations that are not assigned a numeric identifier.

At step 106, a check is performed to identify if another fingerprint F(i) can be generated from the source M.

The method exits to step 120 if no more fingerprints can be generated from the source M.

If another fingerprint F(i) can be generated, it is extracted from the source M at step 108. The step 106 may be performed implicitly by requesting and obtaining or not obtaining the next fingerprint F(i).

Step 112 checks if there is a fingerprint F(X) in the DFL such that F(X)=F(i).

If no match is found on the step 112, the control goes to step 118 where the iteration counter is increased by 1 or another equivalent action of moving to the next iteration is performed.

If a match is found on step 112, the current hierarchical security level L(M) of the source M is compared to the hierarchical security level L(X) of the matching fingerprint F(X).

If the hierarchical security level L(X) is less or equal to the current hierarchical security level L(M) of the source M, control goes to step 118 where the iteration counter is increased by 1 or another equivalent action of moving to the next iteration is performed.

If the hierarchical security level L(X) is greater than the current hierarchical security level L(M) of the source M, then the hierarchical security level L(M) of the source M is set to L(X) at step 116 and control goes to step 118 where the iteration counter is increased by 1 or other equivalent action of moving to the next iteration is performed.

After the iteration counter is increased by 1 or other equivalent action of moving to the next iteration is performed at step 118, control is transferred back to step 106.

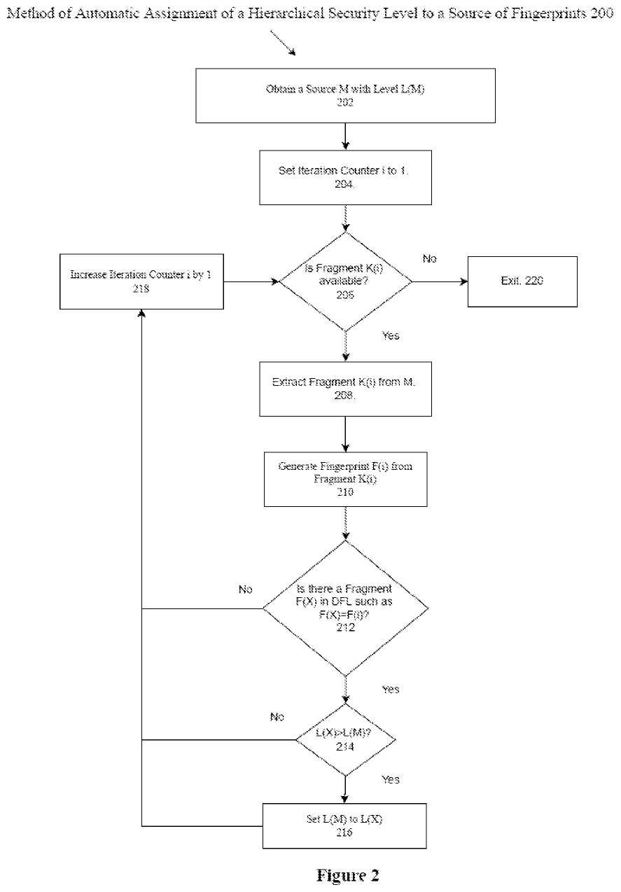

FIG. 2 is a block diagram depicting the method 200 of assigning a hierarchical security level to file M, in accordance with an embodiment.

The method 200 obtains a file M with hierarchical security level L(M) at step 202.

At step 204, an iterative process starts. The iteration counter i is only an indicator to enumerate different steps of the process. The process may use iterations that are not assigned a numeric identifier.

At step 206, a check is performed to identify if another N-fragment K(i) can be generated from the source M.

The method exits to step 220 if no more fragments can be generated from the source M.

If another N-fragment K(i) can be generated, it is extracted from the source M at step 208. Step 206 may be performed implicitly by requesting and obtaining or not obtaining the next N-fragment K(i).

Step 210 generates fingerprint F(i) from the N-fragment K(i).

Step 212 checks if there is a fingerprint F(X) in the DFL such that F(X)=F(i).

If no match is found on the step 212, the control goes to step 218 where the iteration counter is increased by 1 or another equivalent action of moving to the next iteration is performed.

If a match is found on step 212, the current hierarchical security level L(M) of the source M is compared to the hierarchical security level L(X) corresponding to the fingerprint F(X) matching fingerprint F(i).

If the hierarchical security level L(X) of the fingerprint F(X) is less or equal to the current hierarchical security level L(M) of the source M, control goes to step 218 where the iteration counter is increased by 1 or other equivalent action of moving to the next iteration is performed.

If the hierarchical security level L(X) is greater than the current hierarchical security level L(M) of the source M, then the hierarchical security level L(M) of the source M is set to L(X) at step 216 and control goes to step 218 where the iteration counter is increased by 1 or other equivalent action of moving to the next iteration is performed.

After the iteration counter is increased by 1 or other equivalent action of moving to the next iteration is performed at step 218, control is transferred back to step 206.

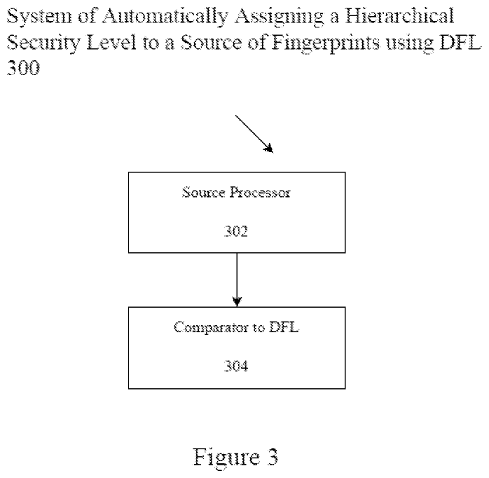

FIG. 3 is a block diagram of the system 300 implementing the method of automatically assigning the hierarchical security level L(M) to a source M by comparing fingerprints F(i) from that source to fingerprints F(X) in the DFL.

The system 300 comprises two elements: Source Processor 302 and Comparator to DFL 304.

The Source Processor 302 is configured to generate fingerprints F(i) from the source M, to obtain the initial hierarchical security level L(M) of the source M, and to pass these values to the Comparator to DFL 304.

The Comparator to DFL 304 is configured to compare fingerprints F(i) generated by the Source Processor 302 from source M to the fingerprints F(X) stored within the DFL. The comparator to DFL 304 is further configured to compare the current hierarchical security level L(M) of the source M to the hierarchical security level L(X) of the matching fingerprints F(X) from DFL and, in the case if L(M) is less than L(X), to set L(M) to equal to L(X).

1. A method for automatically assigning a hierarchical security level to a source M of fingerprints F(i) of N-fragments K(i) with the initial hierarchical security level L(M) with the use of a digital fingerprint library containing fingerprints F(X) of N-fragments K(X) and their hierarchical security levels L(X), the method comprising the steps of:
a. generating one or more fingerprints F(i) from the source M;
b. detecting presence of fingerprint F(X) within DFL such that F(X)=F(i); and
c. in presence of a match:
i. comparing the current hierarchical security level L(M) of the source M to the hierarchical security level L(X) corresponding to the fingerprint F(X) matching the fingerprint F(i); and
ii. in the case when L(X)>L(M), setting L(M) to be equal to L(X).

2. The method according to claim 1, wherein a fingerprint of an N-fragment is its hash value or the N-fragment itself.

3. The method according to claim 1, that further comprises setting the initial hierarchical security level L(M) of the source M to the lowest possible value or according to another predefined rule if the security level L(M) is not assigned to M.

4. The method according to claim 1, wherein the source M is a file or a database of fingerprints F(i), N-fragments K(i) or their sources.

5. The method according to claim 1, wherein the step of generating a fingerprint F(i) from source M further comprises the step of generating an N-fragment K(i) from the source M first, followed by the generation of the fingerprint F(i) from the N-fragment K(i).

6. The method according to claim 5, further comprising the step of generating N-fragments K(i) from a file M using the sliding window method.

7. A system for automatically assigning a hierarchical security level to a source M of fingerprints F(i) of N-fragments K(i) and initial hierarchical security level L(M) using the digital fingerprint library DFL that contains fingerprints F(X) of N-fragments K(X) and their hierarchical security levels L(X), the system comprising:
a. a Source Processor configured to determine the initial hierarchical security level L(M) of the source M and to generate fingerprints F(i) for comparison against DFL;
b. a Comparator to DFL coupled to Source Processor and configured to:
i. for fingerprints F(i) generated from the source M, detect presence of fingerprints F(X) in DFL such that F(i)=F(X); and
ii. in presence of the match, compare the current hierarchical security level L(M) of the source M to the hierarchical security level L(X) corresponding to the identified fingerprint F(X) such that F(X)=F(i) and, if L(X)>L(M), change the hierarchical security level L(M) of the source M to equal to L(X).

8. The system according to claim 7, wherein the fingerprint F of the N-fragment K is its hash value or the N-fragment itself.

9. The system according to claim 7, wherein the Source Processor sets the initial hierarchical security level L(M) of the source M to the lowest possible value or according to another predefined rule if that value is not set.

10. The system according to claim 7, wherein the source M is a file or a database of fingerprints, N-fragments, or their sources.

11. The system according to claim 7, wherein the source M is a file, and Source Processor extracts N-fragments from it using the sliding window process a part of the process of generation of fingerprints.
